(19) United States
(12) Patent Application Publication
(10) Pub. No.: US 2003/0232648 A1
(43) Pub. Date: Dec. 18, 2003

(54) Videophone and videoconferencing apparatus and method for a video game console

(76) Inventor: Joseph Charles Prindle, Santa Monica, CA (US)

Correspondence Address: Joseph Charles Prindle, Suite 211, 1122 18th Street, Santa Monica, CA, 90403, US

(21) Appl. No.: 10/171,227

(22) Filed: Jun. 14, 2002

(51) Int. Cl. G06F 19/00

(52) U.S. Cl. 463/40

(57) ABSTRACT

A videophone and videoconferencing system for multiple video game consoles residing on a network. Each client video game console has a camera and microphone attached, client software executing on the game console, that can be controlled by the video game controller through a Graphical User Interface (GUI), which is displayed from the client video game console on a standard television set. Each console comprises a networked interface card (NIC) or modem, a network connection, and software executing on the client video game console that can establish peer-to-peer or client-to-server network connections. Each console supports the H.323 standard for conferencing, and can send and receive, and encode and decode video and audio signals, and display that and other data on screen. This system and apparatus allows a game console to become a simple and cost-effective method for videophone and videoconferencing between client video game consoles and other client computers, and in one implementation, can be used as a peer-to-peer videophone for a networked game console.

### BACKGROUND OF THE INVENTION

Field Of Endeavor

The present invention relates to the field of telecommunications, principally the field of two-way video and voice communications, and encompasses the area of videophones and videoconferencing. More particularly, the present invention relates to a method and apparatus for combining a videophone system with a video game console to achieve a simple, cost-effective videophone and videoconferencing system.

State Of Technology

The present invention relates to several fields of technology, primarily including telecommunications, which includes videophones and videoconferencing; video game consoles, and the International Telecommunications Union (ITU) H.323 communication standard (described below) for video conferencing over computer networks. The following is a brief description of the state of these technologies.

Telecommunications, Videophones and Videoconferencing

Two-way video and voice communications deals with the generation, processing and transmission of a series of images and the accompanying audio signal in a sequence that is intended to portray motion (e.g. ‘live’). A videophone can be considered a special type of this, in that it produces and utilizes a series of still images and audio signals to convey the idea of a live or constant transmission.

Videoconferencing and videophones have become increasingly popular as the availability of equipment has grown, and the cost of carrying audiovisual data has declined. Pure, stand-alone videoconferencing systems are still relatively rare, based on the fact that these systems typically require new and significant hardware, software and programming, plus they require significant communications network connections, for example, multiple channels of an Integrated Services Digital Network (ISDN) or a T1/E1 broadband connection.

At the same time, home based systems using a personal computer combined with a simple video or web camera and a microphone have dramatically increased in recent years. Many current computers are web-enabled and thus are able to access the Internet network as the basis for the transmission of data. The Internet is a public network, and is formed by an interconnection of computers and other networks, employing standardized protocols to help facilitate the transmission of data.

These conventional computer systems are still difficult to assemble, install and use. This can include the addition of new personal computer hardware, physically connecting several separate devices with multiple connection points, the installation and operation of complex audio/visual software, and device drivers along with the management of network connections and configurations. The result is that the cost of a personal computer, plus the audio and video equipment required, typically has a price in the thousands of dollars. Even with continuing price reductions, unfortunately, that still makes this technology prohibitively expensive for many people. And despite its comparatively wide availablity, conferencing equipment remains, relative to most other consumer products, very difficult to set-up and use for the non-technical user.

Accordingly, a need has remained for a videoconferncing system, equipment and methods that are relatively inexpensive, simple, and easy to use for the consumer. The present invention retains all the advantages of a stand alone, or computer based videoconferencing system in addition to significantly reducing the cost, complexity and difficulty of using current systems.

Video Game Consoles

Home video games systems, also commonly known as video game consoles or consoles for short, can be thought of at their core as a highly specialized computer. The following is a sample list of the game system basics: GUI (Graphical User Interface), CPU (Central Processing Unit), RAM (Rapid Access Memory), software kernel, storage medium for games, video output, audio output, a power supply and now more frequently a modem or Ethernet connection to a network, particularly the Internet. Ethernet is a standard for LAN (Local Area Network) communications, a packet-based data network designed to operate over relatively short distances. It is defined by the IEEE, the Institure of Electrical and Electronics Engineers, in standard IEEE 802.3.

Video game systems, or video game consoles are generally designed to be a part of an entertainment system. This means that it is simple and easy to connect to a television set and stereo. The degree of technical knowledge required to setup a video game system, is generally much lower than for a computer. It is a device intended to be used with a television. All game consoles provide a video signal that is compatible with a standard television, and which may be a NTSC (National Televison Standards Committee) signal, a PAL (Phase Alteration by Line) signal as in Europe, or even SECAM (System Electronique Couleur Avec Memoire) signal. Most consoles also have dedicated graphic processors.

The latest generation of game consoles include the XBOX™, which is a product of the Microsoft Corporation. The XBOX™ is a video game system that allows a user to play video games on their television. While in some ways similar to a personal computer, it does not have a mouse or keyboard, the user interacts with the system by using a video game controller. The PLAYSTATION 2™, also known as the PS2™, a product of the Sony Corporation is currently the most popular video game system. Both the XBOX™, and the PS2™ are a significant improvement over the previous technology. These platforms include support for Universal Serial Bus (USB) devices, modems, and a Network Interface Card (NIC), that results in the fact that it is now technically feasible to use this platform as a basis for a real-time videophone and videoconferencing system.

The present invention utilizes the game consoles strengths to its advantage by using an existing system and equipment, and significantly reducing the cost, complexity and difficulty of using other current videoconferencing systems.

H.323 is an International Telecommunications Union (ITU) standard that provides specification for computers and services for multimedia communications over networks that do not provide a guaranteed QOS (Quality of Service). H.323 equipment is able to carry real-time audio and video data. This standard relies on the Real-Time Protocol (RTP) and Real-Time Control Protocol (RTCP), with additional protocols for signaling and data, provided but the Internet Engineering Task Force (IETF). This allows H.323 equipment to be interoperable with many other end points.

This permits users connected to the Internet to contact other people that are using diverse products that support H.323, similarly to how people using different models and makes of phones can talk to each over over Public Switched Telephone Network Lines (PSTN). The H.323 standard classifies how audio and video information is packaged for transmission over the network. Audio and video coder/decoders (Codecs), encode and decode audio and video sources for communication between nodes.

However the level of special knowledge required to effectively set up and utilize equipment and this protocol is beyond the capabilility of most computer users. The present invention utilizes the advantages of the H.323 standards while at the same time masking the details from the end users, and significantly reduces the complexity and difficulty of using this videophone and videoconferencing system.

With the present invention, the combination of videoconferencing technology, game consoles, and the H.323 standard for Internet videoconferencing, the present invention further provides an improvement by increasing the number of potential users.

To date, there is no mechanism, apparatus or method to provide a real-time videoconferencing system using a video game console and a network connection. The invention described herein provides such an apparatus and method.

### BRIEF SUMMARY OF THE INVENTION

The present invention is an apparatus and method for providing a real-time videophone and videoconferencing system for a video game console. The system of the present invention includes a first video game console for directly linking the first game console with a second video game console, or a computer, or set-top box or similar device, where the first video game console comprises: 1) equipment to capture audio and video data; 2) a network interface linked to a network; 3) client application software executing within the first video game console, the client software includes a) processing logic to support the H.323 standard b) processing logic for a GUI c) processing logic for input from a video game console controller d) processing logic for connecting to a server on a network via the network interface, e) processing logic to connect directly to another video game console by use of a network address.

One embodiment of the present invention includes an apparatus and method for capturing video and audio signals. The system of the present invention for capturing audio and video data comprises: 1) a CCD (Charged Coupled Device) or CMOS (Complementary Metal Oxide Semiconductor) camera; 2) a microphone; 3) an A/D (Analog to Digital) converter; 4) a camera DSP (Digital Signal Processor); 5) a 4-Port USB (Univeral Serial Bus) hub; 6) a USB cable to connect to the game console.

The present invention includes an apparatus and method for the encoding, decoding and display or playback of the audio, video and data. The system of the present invention for the encoding, decoding and display or playback of the audio and video data comprises: 1) an encoder that converts the the analog audio signal to a digital format; 2) a decoder that converts the digital audio signal into an analog signal that can be played back on either a television or supported speakers; 3) an encoder that converts the analog video signal to a digital format; 4) a decoder that converts the digital video signal to an analog signal that can play on a standard television such as PAL (Phase Alternating Line) or NTSC (National Television Standards Committee) formats.

The present invention includes an apparatus and method for supporting the International Telephone Union (ITU) standard H.323 specifcation for computers, equipment and services carrying real-time audio, video and data, or any combination of these over a network. The system of the present invention for supporting H.323 standard contains client software applications and modules that comprises: 1) call signaling and control; 2) audio and video streaming; 3) audio and video codec compatability; 4) a framing and call control unit that adheres to ITU standard H.255.0, which covers protocols and message formats, further comprising of: a) logical framing; b) sequence numbering; c) error detection; 5) the ITU standard Q.931 that defines the basic control procedure for calls and access connections, including link layer protocol handling; 6) the ITU standard H.245 as a control mechanism to allow compatible game consoles or others to connect to each other; 7) the ITU standard T.120, as the mechanism for packaging and sending data comprising: a) file transfer; b) program sharing, 8) support for the Internet Engineering Task Force (IETF) standards: a) Real-Time Protocol (RTP) and b) Real-Time Control Protocol (RTCP).

The present invention also includes an apparatus and method for a Graphical User Interface (GUI) to control specific application functions by using a game console controller. The system of the present invention for an apparatus for a GUI comprises: 1) the ability to place a call; 2) select the video and audio quality of the call; 3) look up another client address either on an independent server or over a nework like a phone book; 4) select and control of window display size; 5) select and control of chat functions; 6) select and control of file transfer functions; 7) select and control of sharing applications and/or programs.

The present invention also includes an apparatus and method for client application software for the game console to be executed by the game console. The system of the present invention for execution by the game console comprises: 1) processing logic in the machine language format that can be read and executed by the game console.

It is an object of the invention to provide a low-cost and easy to use videophone and videoconferencing system utilizing a game console, which may be combined with a standard television set. The abilities of the invention include:

Ability to transmit and receive continuous audio, video and data stream between 2 video game consoles connected to a network

Display received video signal on a standard television set

Play received audio over speakers and/or on a standard television set

Support H.323 Standard and communicates directly between clients and nodes

Distribute data over an Internet Protocol (IP) network

The present invention is an innovative and new commercial videophone and videoconferencing product that integrates with a video game console system which has a network or Internet connection, creating a simple, and cost-effective multimedia communication system over the network. The participants in a videoconference using a video game console and the present invention can ‘see and hear’ each other independent of their physical location. In fact, combined with a video game console and a televison, the present invention provides a person with a complete videophone, and allows that person the ability to video conference (constantly transmit video, audio and data) from anyplace in the world—cheaply and simply.

The present invention combines hardware and software to capture video images and audio sounds, processing logic in a software application to format and deliver the information over a network, uses a GUI displayed on a television that is linked with the video game console operating system or kernel, and manages the connections required for hardware to support audio and video capture for the video game console. It involves the continuous capture, compression, transmission and display of video images from a video camera, and the transmission of voice and images through a network like the Internet, using the video game consoles modem or ethernet connection. This device may also include a network hub, and one embodiment of the present invention utilizes the daisy chain method of connection and enumeration for hardware devices. The daisy chain method of connecting a series of peripherals on a bus in a chain, is where devices are connected serially to each other, and where a signal is sent from the CPU along this chain of devices, and passed to the requested device.

This invention comprises the ability to capture voice and video, digitize the information, compress the data on the sending side, and formatting and sending the information over an IP network, On the receiving end, it has the ability to receive the IP data, decompress the received audio and video data, convert that to an analog signal and ‘play’ both the video and audio information on a television set.

Another object of the invention is the ability of the system to be remotely controlled and programmed such that the operation of the system can be synchronized with other computers, including changing the transmission rate, and automatically adjusting the microphone sensitivity level.

These and other advantages of the present invention are fully described in the following detailed description of the preferred embodiment.

### BRIEF DESCRIPTION OF THE DRAWINGS

FIG. 1 illustrates the system overview of how the present invention operates.

FIG. 2 illustrates the individual components and connections of a client system according to various embodiments of the present invention.

FIG. 3 illustrates a view of a multi-port connection according to one emodiment of the present invention.

FIG. 4 illustrates a single-port or networked hub connection according to one embodiment of the present invention.

FIG. 5 illustrates a USB network hub according to one emodiment of the present invention.

FIG. 6 illustrates a high level abstract of a game console system with which the present invention operates.

FIG. 7 illustrates the software architecture components of the present invention.

FIG. 8 illustrates the network interoperability of the present invention

FIG. 9 illustrates the logic flow of the present invention.

FIG. 10 illustrates a Graphical User Interface (GUI) of one embodiment of the present invention.

FIG. 11 illustrates an example videophone call of one embodiment of the present invention.

### DETAILED DESCRIPTION OF THE INVENTION

A method and apparatus for a videophone and videoconferencing system that operates in conjunction with a video game console are herein described. In the following description, for purposes of explanation, numerous specific details are set forth in order to provide a thorough understanding of the present invention. It will be evident however, to one skilled in the art that the present invention may be practiced without these specific details. In other instances, well known structures, industry standards and devices are shown in block diagram form in order to facilitate description. In other instances, well know structures, interfaces and processes have not been shown in detail in order not to unecessarily obscure the present invention.

In one embodiment, steps according to the present invention are embodied in machine executable software. In other embodiments, hardware and electronics may substitute, or be used in combination with, the machine executable software to implement the current invention.

The present invention interacts with a system comprising: a commercial video game system in which a video game console is connected to a television, and a plurality of video game consoles, computers or other devices that are connected through a network, by a modem or network interface card (NIC), to a packet based network such as the Internet. The video game console includes a processing system that executes machine readable code, commonly called a video game title, containing software that enables a user to view a video signal on the television, hear an audio signal over speakers, the ability to interact with the software and control devices, and make selections through a graphical user interface (GUI) which are visually displayed on the television, and that receives this input from a video game controller.

For purpose of clarification, a videophone will be considered a special type of computer based videoconferencing technology, in that it produces and utilizes a series of still images to convey the idea of a live or constant transmission.

The result of the present invention, when used in combination with a video game console system, is the first multi-media conferencing system and a videophone specifically designed for a video game console, and one that is simple, easy to use and is also currently the most cost effective way to offer the capabilities of full-motion, live video over a network.

I. System Overview

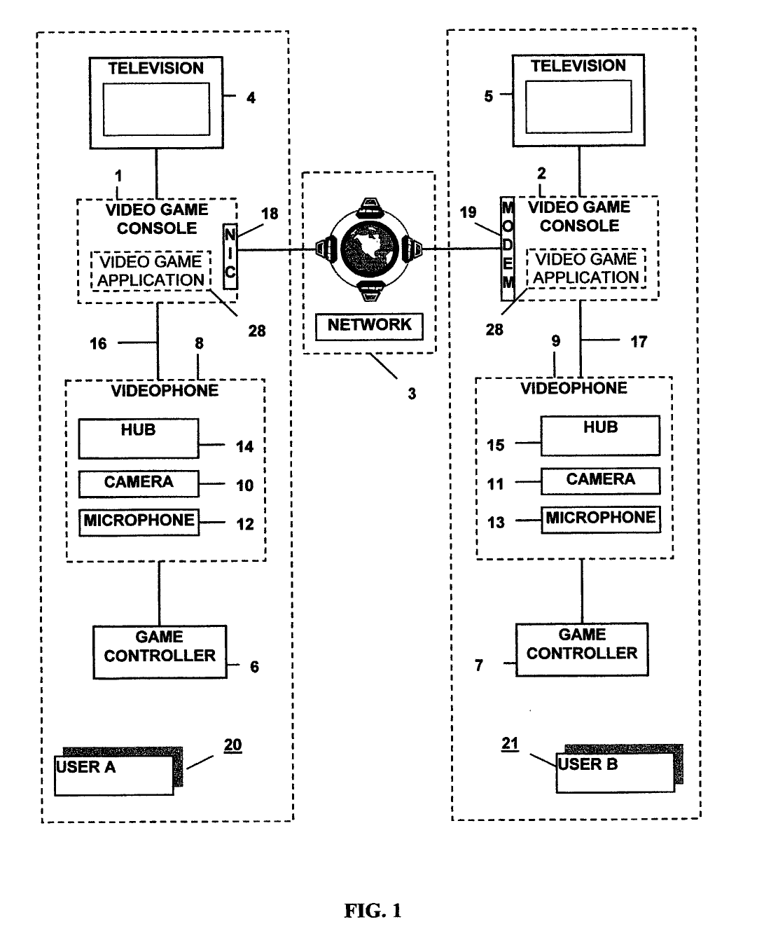

FIG. 1 depicts a system overview, and also includes a sample configuration for connecting the present invention(s) to make a video conferencing call, by integrating with a video game console which is connected to a network, according to one embodiment of the present invention. In this case it is illustrated by way of a line drawing diagram. While multiple clients of the present invention may be included in this architecture, for purposes of simplicity, in this case the system and apparatus comprise 2 systems (20,21) which are connected to a network (3). The clients or game consoles (1,2) are each connected to a television set (4,5) for playing video and audio signals. The video game consoles, including the video game controllers (6,7), are connected to the videophones (8,9). As will be described in further detail below, in this example each endpoint node or videophone system (the present invention) comprises a video camera (10,11), a microphone (12,13), and a network hub (14,15). This is connected to the video game console by way of cabling (16,17). Machine executable code (28), also known as a video game application or title, runs within the game console. The game consoles themselves (1,2) are connected to a network interface, which contains a method or apparatus, such as a network interface card (NIC)(18) or modem (19), which is connected to a network, for example the Internet or a Local Area Network (LAN) (3).

In view of the architecture shown in FIG 1., there are clearly several economic and technical reasons for using the present invention as the most effective method and apparatus to offer full mutli-media conferencing and videophone capabilities when compared to any current system capable of the same. These are listed in order of relative strengths:

1. Cost. The current video game consoles are significantly cheaper than any of their counterparts as a medium capable of displaying video and audio signals. By comparison, machines that are also capable of the same, which include but are not limited to a desktop system using a personal computer, a stand-alone or “roll-about” system where all the electronic equipment required for a videoconference is contained in a transportable cabinet, and set-top or cable boxes, are all considerably more expensive.

2. Simplicity. When the present invention is combined with the well known, and well established art of video game controller functions, once connected, it allows a user of the system to place a videophone call with essentially a single push of a button. Compared to the relative ease of use, quality, and convenience of other systems, very few things can be simpler and easier than pushing a single button on a video game controller to launch a video conference over the Internet on a television set.

3. Effectiveness. By utilizing the current base of existing technology, including video game consoles and the ubiquitous television, the present invention offers the additional advatange of significantly reducing the barriers to video conferencing to more people and businesses. The present invention can offer the long awaited promise of an inexpensive, very simple, and effective way to create a videophone and multimedia conferencing system.

II. Client System Objects

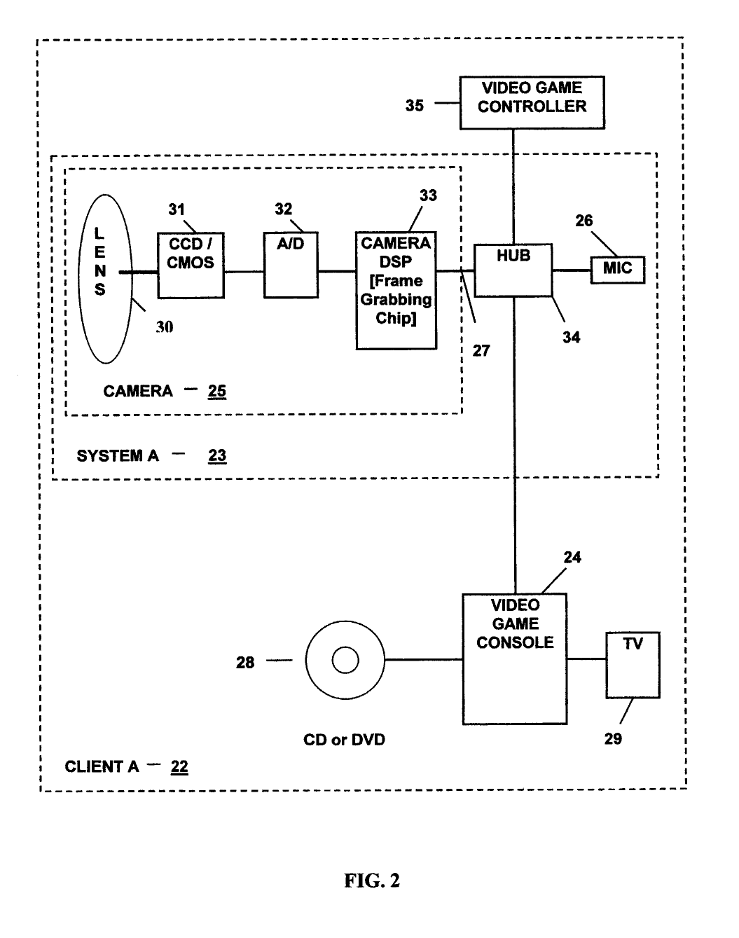

FIG. 2 illustrates a complete client system (22) for a video game console, according to one embodiment of the present invention. The core of the client system, which includes everything in system A (23), also includes the video game console (24), hardware for the capture of video (25) and audio (26) data, cabling to connect the devices (27), executable machine code (28) in the form of an video game application that is read from the video game console CD or DVD device or a network server, a video game controller (35), and a standard television set (29).

Components

A. CD, DVD or ROM Game Cartridge

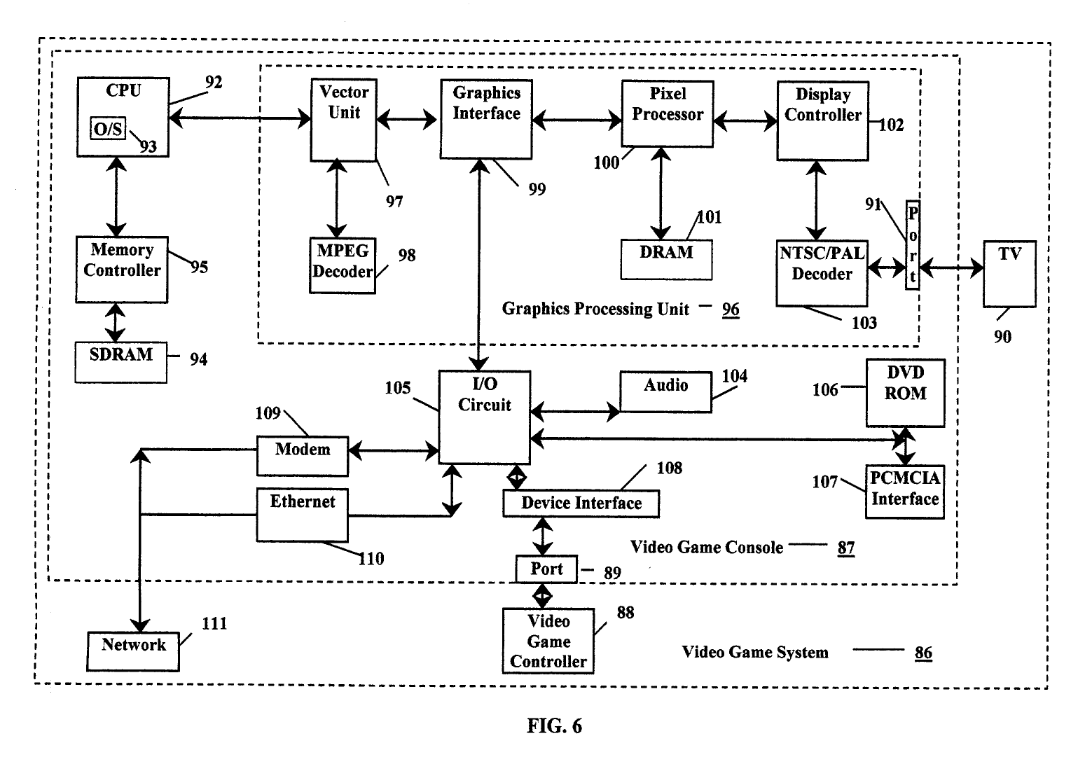

This is a video game title, or machine readable medium (28) that contains the exectuable, or machine language to be executed within the video game console. This is described in further detail in FIG. 6.

B. Camera

It consists of a simple camera. The essential function of the camera is to convert captured light through a lens (30) into electrons. Two common types of this are the CMOS and CCD type cameras (31). An analog to digital (A/D) converter (32) turns each pixel into a digital value. It contains a Digital Signal Processor (DSP) (33), sometimes known as a frame grabber, that ‘grabs’ a frame of data from the camera on a periodic basis. It is connected with a cable to either a hub (34), or the controller port of the game console. Executable machine code running on the (28) video game console, then turns the image in a standard image, such as a JPEG file. The machine code can support multiple hardware manufactures and Original Equipment Manufacturers (OEM).

C. Microphone

The microphone (26) is a simple device that can detect minute amounts of air pressure. It measures varying pressure waves in the air and converts them to representative varying electronic signals. The machine code can support multiple hardware manufactures and OEM's.

C. Hub

FIG. 2 shows one embodiment of the present invention utilizing a Universal Serial Bus (USB) Hub (34) for device connection. The USB hub provides a single, simple, standardized method to connect peripheral devices to a computer or similar device. The hub can be powered or unpowered, but the preferable USB Hub for the present invention is powered and contains its own transformer that supplies power to the bus. It works on the process of enumeration which assigns an address to the individual components. The camera and microphone attached to this hub work best in the isochronous mode, hosted in real-time. Isochronus mode is a time-scale or signal, such that the time interval between the data either have the same duration or durations that are integral multiples of the shortest duration between data. This could also be a firewire (IEEE 1394) or other computer standard connections.

D. USB Cable

The USB cable (27) is one way to connect devices to the game console or the USB Hub (34) as described above. It contains two wires for power, a +5 volt and ground, and a twisted pair of wires to carry data. The cable is also shielded, and the game console acts as the host.

E. Game Console

At its core, a video game system or console (24) can be defined as a highly specialized computer. In fact, most systems are based on the same central processing units (CPU) that are used in many desktop computers. And to keep the cost down, most manufacturers use CPU's that have been widely available for long enough to undergo a significant cost reduction. The price range is currently around $300, which makes it much more inexpensive than a computer. It is designed to be easily connected to a television and stereo. The present invention capitalizes on that fact by providing a simple, inexpensive and easy to use video conferencing system.

The list of components that all game consoles share in common are, a user controller interface, CPU, RAM, software kernel, storage medium for games, video output, audio output and a power supply.

The user control interface allows the user to interact with the game console. Most consoles use Rapid Access Memory (RAM) to provide temporary storage of the application. The software kernel can be thought of the console's operating system. The two most common storage technolgies used today are Read Only Memory (ROM) cartridges, and CD or DVD's.

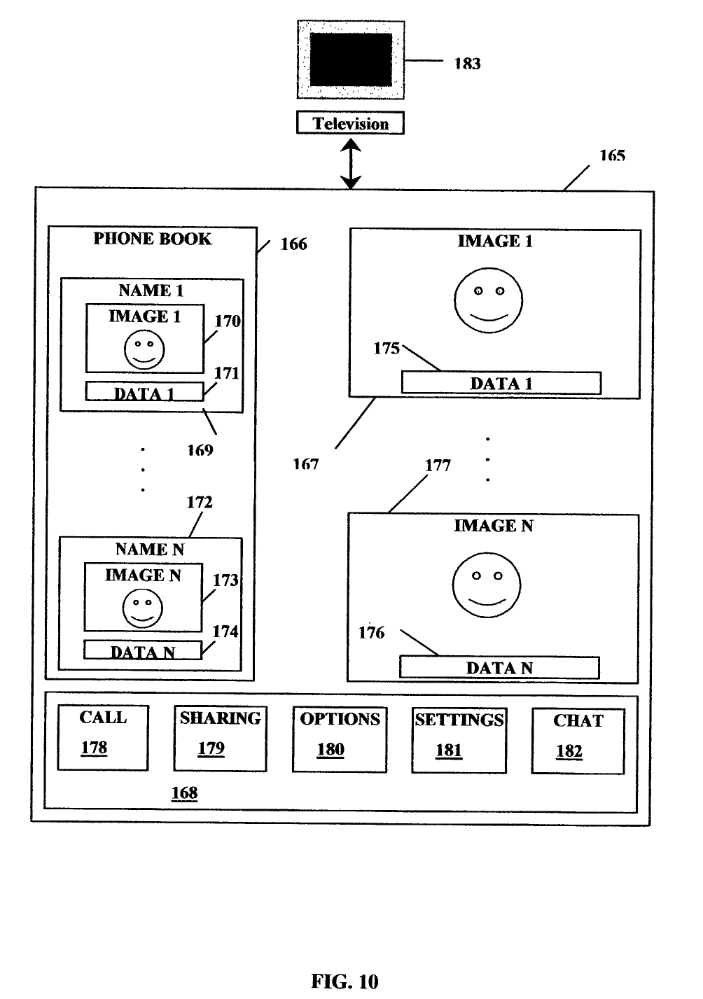

The game console is described in much greater detail below, in association with FIG. 10.

F. Controller

There are several different types, including force feedback, paddles, joy sticks and others, but basically the video game controller (35) functions by interacting with the game console software and the software operating system Application Program Interface (API), and provides visual images clues on the screen.

G. Television

FIG. 2 shows a standard televsion (29) that converts input signals to video images that can be viewed. The game console (24) provides a video signal to the televison, and depending on the country of origin, this may include NTSC, PAL or even SECAM standard video output.

FIG. 2 represents a videophone as a type of the present invention, in that it produces and utilizes a series of still images to convey the idea of a live or constant transmission.

III. Device Connection—Multi-Port

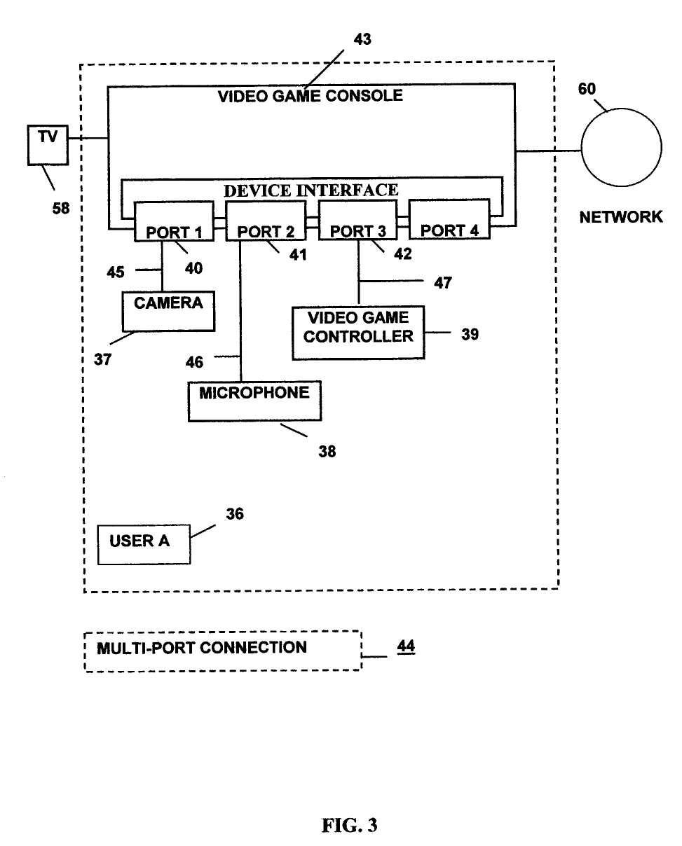

FIG. 3 and FIG. 3B illustrate a connection configuration for one emodiment of the present invention. In FIG. 3, for User A (36), the individual component devices, camera (37), microphone (38), and video game controller (39), are all connected directly to individual ports 1 through 3 (40, 41, 42) on the video game console (43). Each device of the multi-port connection configuration (44) is connected through cabling (45, 46, 47), such as USB, Firewire, or a serial interface.

IV. Device Connection—Single-Port

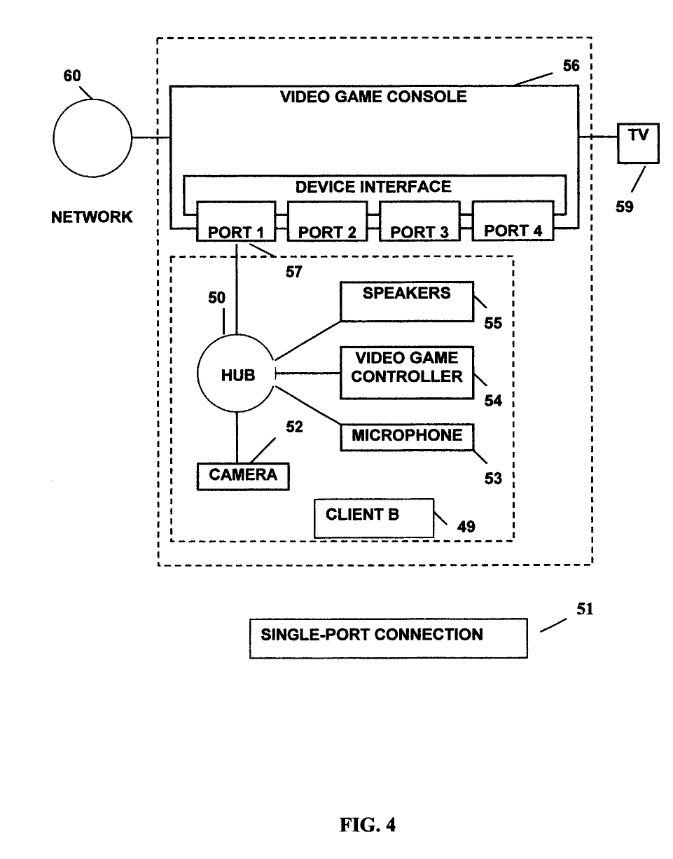

In FIG. 4, the Client B system (49) contains a device hub (50), into which the individual devices for the single-port connection configuration (51) of the camera (52), the microphone (53), the video game controller (54), and the optional speakers (55), are connected. The present invention, through the hub is then directly connected to the video game console (56) through a single port (57). Both systems are connected to a televison (58,59) and to each other by way of a network (60).

V. Device Connection—Single Port USB HUB Component

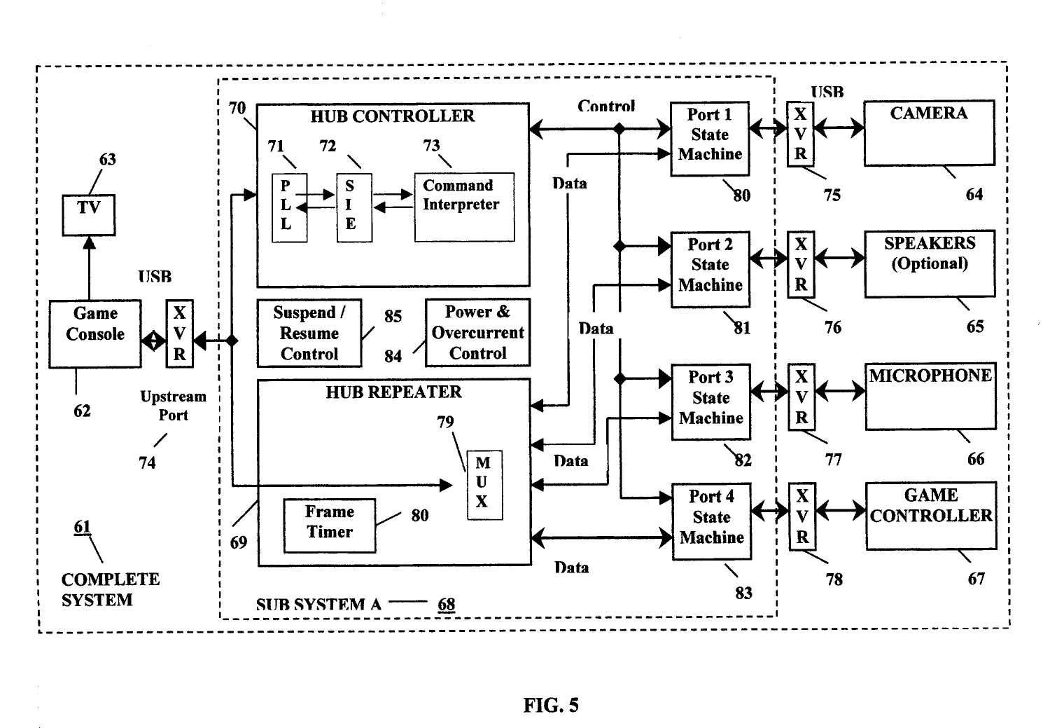

FIG. 5 illustates one embodiment of the present invention, which includes a central hub component, which logically connects the separate peripheral devices to one central device. In this example of the present invention, the Complete System (61) includes the video game console (62), the television set (63), a camera (64), speakers (65), a microphone (66) and a video game controller (67). Sub System A (68) herein contains a Universal Serial Bus (USB) hub operating under the USB standards and specifications.

The role of the system software, operating on the video game console (62), is to provide a uniform view of the Input and Ouptut (I/O) for the software application. This system manages the dynamic attachment and detachment through the process of enumeration, and involves communicating with devices such as the camera (64).

In FIG. 5 the USB Hub Core (68) consists of the Hub Repeater (69) and the Hub Controller (70). The Hub Repeater (69) is responsible for the connectivity setup and tear-down and supports exception handling such as bus fault detection/recovery and connect/disconnect. The Hub Controller (70) provides the mechanism for host to hub communications. Hub specific status and control commands permit the host (the application running on the video game console (62)) to configure a hub and to monitor and control its individual downstream ports. The USB Hub Core (68) is comprised of the following main blocks as described below:

The Hub Controller Block (70) contains the digital Phase Lock Loop (PLL) (71) which extracts the clock and data from the USB cable, the Serial Interface Engine (SIE) (72) to handle the bit level protocol on the USB, to convert serial data to parallel and vice-versa, and a Command Interpreter (73). The Command Interpreter decodes the standard commands, hub class commands and provides the necessary Hub/Port status to the host. In addition, the Command Interpreter contains the USB standard descriptors such as device descriptor, configuration descriptor, interface descriptor, endpoint descriptor and Hub descriptors. The descriptor data is provided to the host, the video game console (62), when requested. The Command Interpreter maintains the Hub status and change registers, the Port status and change registers.

The Hub Repeater Block (69) handles the connectivity between the upstream port (74) and the downstream ports (75, 76, 77, 78). It takes the signals from the upstream or root port and all downstream ports and establishes the connectivity between one downstream port and the upstream port or from the the upstream port to all downstream ports based on the current state of the port state machine. A multiplexer (MUX) (79) is used to select the data coming from the downstream ports for upstream connectivity.

The Frame Timer Block (80) contains the USB Hub Frame Timer logic. It generates the End Of File (EOF) 1 and EOF 2 points in all frames that are used by the Hub Repeater Block for establishing the connectivity between the ports.

In FIG. 5 the Port State Machine Blocks (80, 81, 82, 83, 84) control the downstream ports. There is one block per downstream port. These state machines detect the connect/disconnect events on the port and have the capability to enable/disable/suspend the port. It reports the port status and change information to the Command Interpreter (73) for association, and detects whether the device attached is full or low speed. Based on device type, this block converts speeds between the upstream and downstream ports. It also generates the low speed keep-alive strobes if a low speed device is connected.

The Power and Overcurrent Control (84) contains the power switching mode and over-current protection control logic. This block is programmable by the user to support different power switching modes and over-current protection modes. This controls the power switching for all Port State Machines and monitors the overcurrent condition from all downstream ports.

The Suspend/Resume (85) Control contains the hub functional state machine and handles all the USB suspend/resume events as both a hub as well as a USB device.

VI. Video Game Console System

FIG. 6 is a diagram of the current state of the art in video game system architecture. Presently, most consumer based based video game console are a type of specialized computer, built around a microprocessor. This system architecture is similar to those commonly in use by at home by consumers, for example the XBOX™, which is a product of the Microsoft Corporation, the GAMEBOY™, a product of the Nintendo Corporation, and the PLAYSTATION 2™, a product of the Sony Corporation. The system herein described is collectively called the video game system according to one embodiment of the present invention.

A logical example of a typical video game system is described here for purposes of clarification of the current state of the art. The video game system (86) is comprised of a video game console (87) and a video game controller (88), connected to a port at the back of the game console (89). A standard television set (90) is connected to a port at the back of the game console (91), and the television acts as a monitor with speakers. The controller (88) is operated by the user for inputing data, which is translated into a set of executable operations for the central processing unit CPU (92) of the video game console.

In FIG. 6 the video game console (87) of a typical system is comprised of the following major components:

a) a central processing unit (CPU) (92);

b) an operating system (93);

c) memory (94), such as Random Access Memory (RAM) (95), and a memory controller (59);

d) a graphics processing unit (GPU) (96) consisting of: a vector unit (97), a MPEG decoder (98), a graphics interface (99), a pixel processor (100), and RAM (101), a display controller (102), and a NTSC/PAL decoder (103);

e) audio processor (104);

f) video decoder (98);

The Input and Output (I/O) consists of the following components:

a) Input Output Circuit (105)

b) Removable Storage

a. Compact Disk Read-Only-Memory (CD-ROM) or Digital Versatile Disk (DVD) (106), a Personal Computer Memory Card International Association (PCMCIA) interface (107);

c) Ports

a. The device interface (108) may contain anyone of the following: Parallel, Serial, USB, or Firewire (IEEE 1394);

d) Internet/Network Connection

a. Modem (109), Ethernet (110); which may be connected to a Network (111) by a Cable modem, or Digital Subscriber Line (DSL);

To establish the environment of the video game console, in which the present invention operates within, a standard video game console session will be described. When the game console is powered on, a power-on self test is performed including a test to check if the video card is operational, memory tests, loads special drivers, and detects peripheral devices.

Then the bootstrap loader loads the operating system into memory and allows it to begin operation. It does this by setting up the divisions of memory that hold the operating system, user information and applications. The bootstrap loader then establishes the data structures that are used to communicate within and between the sub-systems and the applications of the video game console. Finally, it turns control of the video game console over to the operating system.

Once the operating system of the video game console has been loaded, the operating systems tasks fall into 5 broad categories of operation:

1. Processor Management—Breaking the tasks down into manageable chunks and prioritizing them before sending them to the CPU—central processing unit.

2. Memory Management—Coordinating the flow of data in and out of RAM and determining priorities.

3. Device Management—Providing an interface between each device connected to the video game console, the CPU, and game applications.

4. Application Interface—Providing a standard communications and data exchange between games and the game console.

5. User Interface—Providing a way for the user to interact with the video game and the video game console.

At this time, a user inserts a DVD into the game console. Several components work together from here as the DVD drive reads the video game and other information that is stored on that disk. The operating system determines that the video game is active, and displays a video game menu allows the user to input data to the game through the video game controller. The operating system determines the format that the data is in, and stores information in RAM.

Each instruction from the game controller is sent by the operating system to the CPU. These instructions are intertwined with instructions from other programs that the operating system is overseeing before being sent to the CPU. At this time, the operating system is steadily providing display information to the graphics unit, directing what will be displayed on the televison or screen, as well as the generation of an audio signal played concurrently.

If the game console is capable of receiving input from another source such as the Internet, through a modem or network card, the operating system seamlessly integrates all incoming and outgoing information the video game.

So one can see how the present invention of the videophone for a game console operates. The present invention is connected through a port on the video game console. The present invention contains a camera, microphone, a bus, and a DVD. On the DVD contain the videophone in the format of a video game.

The computer readable program product according to the present invention is a computer readable program storing a game program. The computer readable program is comprised of a CD-ROM, DVD or is stored on a network server that the game console can connect to. The program product stores a process for executing the functions for a video conference between machines or devices.

The intention is not to obfuscate the invention with details of video game consoles that are known to those knowledgable in the art, but to generally illustrate the device in order to clarify the enviroment in which the present invention operates.

VII. Client System Software Architecture and Components

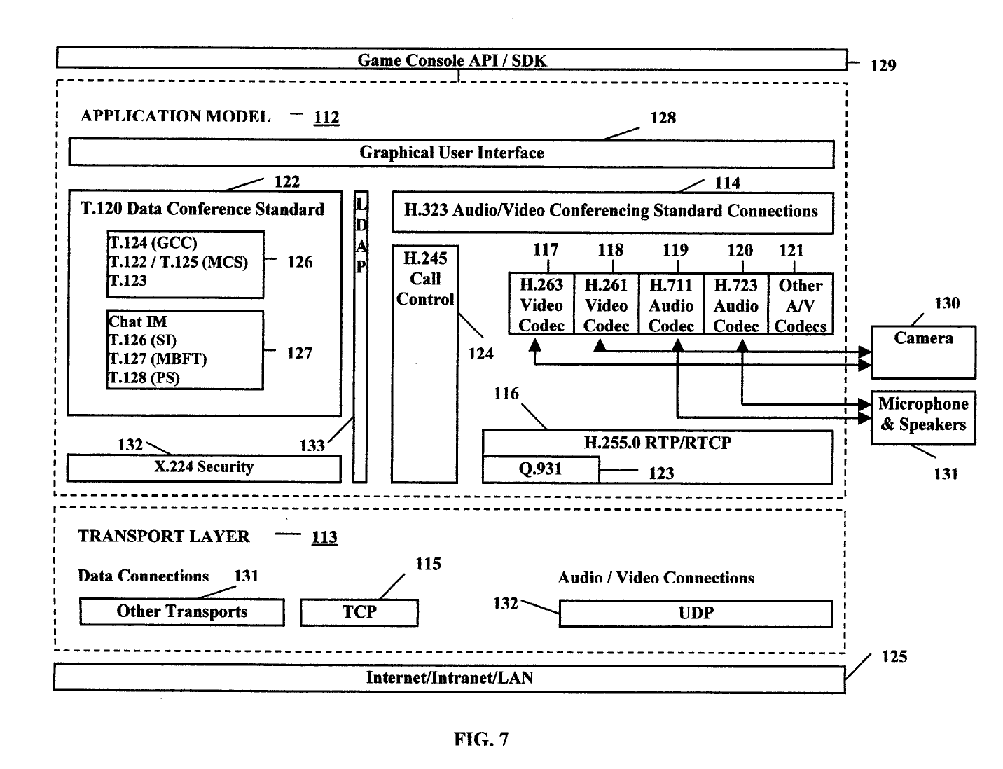

The client software of the present invention, can be roughly divided into two distinct categories of logic. The first part of the software architecture and it components are illustrated in FIG. 7 as the Aplication Model (112), which is responsible for interaction with the operating system and providing an interface to the system. Serving as a window for a video phone call or video conferencing with the video game console and to the O/S (129), it handles the GUI (128), general network access, flow control, error recovery and transfers.

The second part of the software architecture and its components are illustrated as the Transport Layer (113) and is the mechanism of the present invention that is responsible for reliable, transparent transfer of data between end points. Providing end-to-end error recovery and flow control, it deals with packet handling, the repacking of messages, dividing messages into smaller packets and error handling.

FIG. 7 illustrates the software architecture components for the client system according to one embodiment of the present invention. The software is published as a video game title for video game consoles. Using that game title based format, the present invention was developed with video conferencing features based on the H.323 standards (114) and existing infrastructure, which allows the present invention to interoperate with other H.323 standard based products. These are the core functionalites of the client software for the present invention:

A. The Ability to Establish and Maintain Audio and Video Connections.

Two participants can establish a videophone call with the present invention with audio and video over a Transmission Control Protocol/Internet Protocol (TCP/IP) connection. With H.255.0 (116), multiple audio and video streams transport inbound and outbound information. With H.323 protocols, users of the present invention can communicate with and transmit data to other compatible audio or video clients. In addition, a Multipoint Control Unit (MCU) allows multi-user audio and video conferences between mutiple clients as well as other H.323 compatible products.

B. The Ability to use Codecs that Optimze Internet Connections.

The present invention provides a suite of codecs operating between 4.8 Kilobits per second (Kbps) and 64 Kbps that can support various game console, computer and connection types. For optimal preformance over the Internet, the present invention specifies the ITU standard H.263 (117) and the ITU standard G.723 (120) as the default codes. The invention can negotiate other codecs, such as ITU standard H.261 (118) or the ITU standard G.711 (119), depending on the requirements of the other compatible products. Also, the present invention provides appropriate payload formats and handlers for custom codecs (121).

C. The Ability to Support the ITU Standard T.120 for Data Communications.

The present invention creates the association between T.120 (122) and H.323 during a conference. This association allows the two separate parts to operate independently but appear to the user as occuring as a single call.

It is also expected that as future additions are included with the H.323 standard, improved security and a greater range of interoperability with streaming media, servers and others will take place.

Framing and Call Control

H.255.0

First is the code that makes up the System Control Unit (116), which provides call control and framing capabilities. Using H.255.0 standard defines the layer that formats the transmitted video, data, audio and control streams for output to the network, and retrieves the corresponding streams from the network. As part of audio and video streams, H.255.0 uses the packet format specified by the Internet Engineering Task Force (IETF), Real-Time Transport Protocol (RTP), and Real-Time Control Protocol (RTCP) to accomplish the following tasks:

1. Logical Framing

Defines how the protocol frames (packages) the audio and video data into bits (packets) for transport over a selected communications channel.

2. Sequence Numbering

Determines the order of the data packets transported over a communications channel.

3. Error Detection

After initiating a call, one or more RTP or RTCP connections are established. Multiple streams allow H.255.0 to send and receive different media types simulatneously, each one with their own sequence numbers and quality of service (QOS) options. With RTP and RTCP support, the receiving node synchronizes the received packets in the proper order, so the user hears or sees the information correctly.

4. Registration, Admission and Status

5. The H.255.0 standard also is used to communicate with a gatekeeper. A RAS signaling channel makes the connections between the gatekeeper and the H.323 components that are available. The gatekeeper controls the H.323 terminal, gateway and MCU access to the the Local Area Network (LAN) (125) by granting or denying persmission to the H.323 connections.

Q.931

Next is the protocol that defines how each H.323 layer interacts with peer layers so that the participants can interoperate with agreed upon formats. The Q.931 (123) protocol resides within the 2.550.0 protocol. As part of the H.323 call control, Q.931 is a link layer protocol for establishing connections and framing data. This provides a method for defining logical channels inside a larger channel. The Q.931 messages contain a protocol descriminator that identifies each unique message with a call reference value and a message type. The H.255.0 layer then specifies how these messages are received and processed.

H.245

This standard provides the call control mechanism that allows H.323-compatible terminals to connect to each other. H.245 (124) provides a standard means for establishing audio and video connections—the series of commands and requests that must be followed for one component to to connect and communicate with each other. This standard specifies the signaling, flow control, and channeling for messages, requests and commands.

The built-in framework of H.245 enables codec selection and capability negotiation within H.323. Bit rate, frame rate, picture format, and algorithm choices are some of the specific elements negotiated by H.245.

Audio and Video Codecs

Codecs define the format of audio and video information and represent the way audio and video data are compressed and transmitted over the network (125) and to the camera (130) and microphone or speakers (131). H.323 provides a variety of options for audio and video coding. Two codecs, ITU standard G.711 (119) for audio and ITU standard H.261 (118) are required by the ITU standard H.323 specification. H.323 terminals must be able to send and receive A-law and μ-law coding algorithms, as determined by the International Telecommunications Union, Telecommunications Standardization Sector (ITU-T). Additional audio and video codecs provide a variety of standard bit rate, delay, and quality options that suitable for a range of network selections. Using H.323, products can negotiate nonstandard audio and video codecs.

The following describes the above mentioned codes, plus two others that are examples of preferred codecs for videophone connections:

G.711

In FIG. 7 this codec (119) transmitts at audio at 48, 56, and 64 Kilobits per second (Kbps). This is a high rate audio codec, appropriate for audio over high speed, or broadband conections.

G.723

This codec (120) specifies the format and algorithm used to send and receive voice ommunications over a network. It operates at 5.3 Kbps, and 6.3 Kbps, which significantly reduces the bandwidth required and makes it preferable for internet connections, especially thoise established with a modem.

H.261

This codec (118) transmitts video at 64 Kbps (VHS quality). This is a high rate video codec, appropriate for video over high speed, or broadband conections.

H.263

This codec (117) specifies the format and algorithm used to send and receive video communications over a network. This codec supports the Common Interface Format (CIF), the Quarter Common Interface Format (QCIF), and the Sub Quarter Common Interface Format (SQCIF), picture formats which are inherently superior for Internet transmissions, especially low bit rate connections such as those established by a modem, for example one at 28.8 Kbps.

T.120 Data Communications

H.323 makes a provision for using T.120 (122) as the mechanism for packaging and sending data. T.120 can use the H.255.0 layer to send and receive data packets or simply create an association with the H.323 session and use its own trasnport capabilities to transmit data directly to the network. Data from conferencing programs, such as file transfer and program sharing, use T.120 support to operate in conjunction with H.323 connections, Also, H.323 compatible products interoperate with data conferencing products developed under the T.120 specification. This includes T.124, T.122/T.125 and T.123 (125). Also supported are Chat, Instant messaging, T.126, T.127, and T.128 (126). X.224 (132) is utilzed for security.

Light Weight Directory Access Protocol—LDAP

Responsible for the support of connections between sessions, LDAP (133) performs administrative tasks and security. Providing the control structure for communication between applications, it establishes, manages and terminates connections (sessions) between video game consoles, personal computers or cooperating applications.

VIII. Interoperability

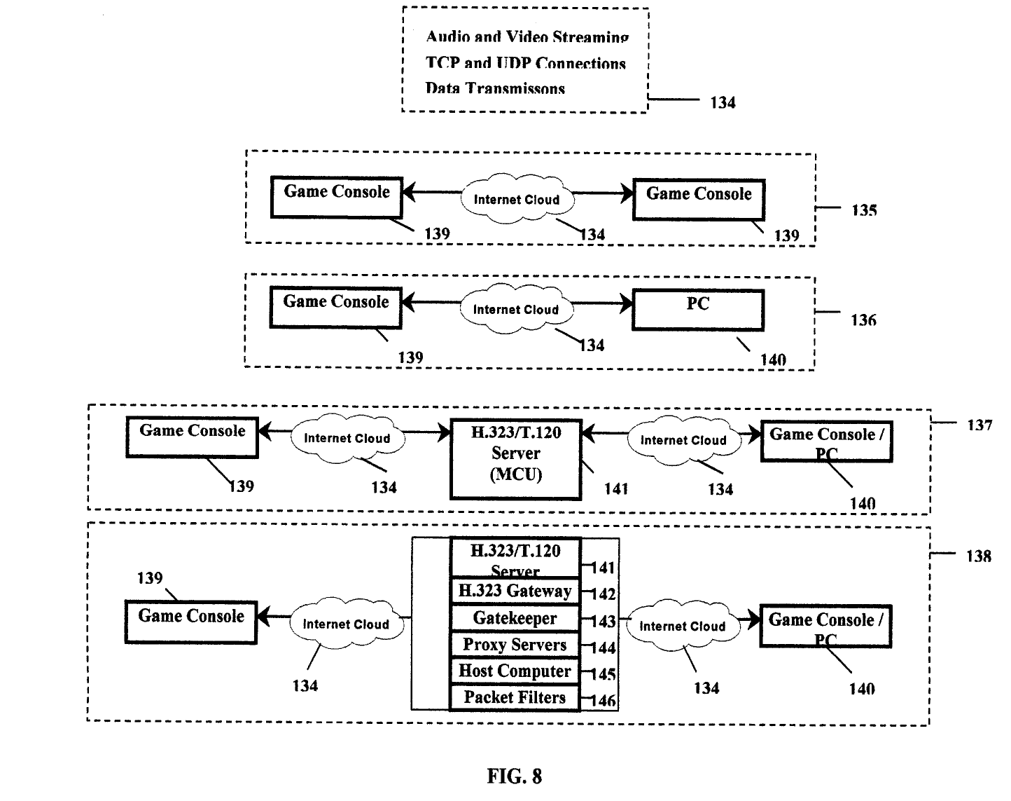

FIG. 8 illustrates the support and interoperability of the present invention to establish a conference over Transmission Control Protocol/Internet Protocol (TCP/IP) connections with the appropriate data flow and sequencing. The ability of each client includes audio and video streaming, TCP and UDP (134) connections, along with data transmissions. In addition to this H.323 terminal architecture, additional components can be implemented as described below:

Peer-toPeer

The present invention is capable of connecting any video game console to another similar video game console, or any video game console to a personal computer or a simliar device, in a peer-to-peer (135) connection scheme, wherein the other devices (140) are also capable of supporting H.323 standard client protocols.

Multipoint Control Unit

A multipoint control unit (MCU) (141) in an H.323 conference, also sometimes called conferencing servers, or conferencing bridges, allow three or more H.323 terminals or clients, to connect and participate in a multipoint conference. A MCU includes both multipoint controllers, which manage the H.323 terminal functions and capabilities in a multipoint conference, and multipoint processors, which process the audio, video, and data streams between the individual H.323 terminals.

Gateway Device

H.323 conference gateways (142) make H.323 terminals on a Local Area Network (LAN) available to H.323 terminals on a Wide Area Network (WAN) or another H.323 gateway. Gateways act as the translation mechanism for call signaling, data transmission, and audio and video transcoding. Gateways satisfy part of the interoperability vision of H.32X products, due to the ability to connect to each other. These Gateways can serve the following functions:

1. The Gateway could bridge a H.323 call to another type of call, such as a telephone. Potentially, this invention could any telephone in the world.

2. The Gateway could bridge a H.323 call to H.324, which is audio and video transmission over an Integrated Services Digital Network (ISDN).

3. The Gateway could bridge different networks; an organization could put a bridge on a firewall to connect an internal corporate network to accept incoming calls.

Gateway functions act like an MCU for establishing video conference calls over networks. The gateway most typically is a point-to-point or peer-to-peer connection, where one endpoint is an H.323 device.

Gatekeeper Device

Gatekeepers (143) provide network services to H.323 terminals, MCU's and gateways. H.323 devices register with gatekeepers to send and receive H.323 calls. Gatekeepers give permission to make or accept calls based on a variety of factors. These Gatekeepers can provide network services such as:

1. Controlling the number and type of connections allowed across the network.

2. Routing calls to correct destination.

3. Determining and maintaining network addresses for incoming calls.

Other bridges also include Proxy Servers (144), a host computer (145) or packet filters (146).

IX. Logic Flow

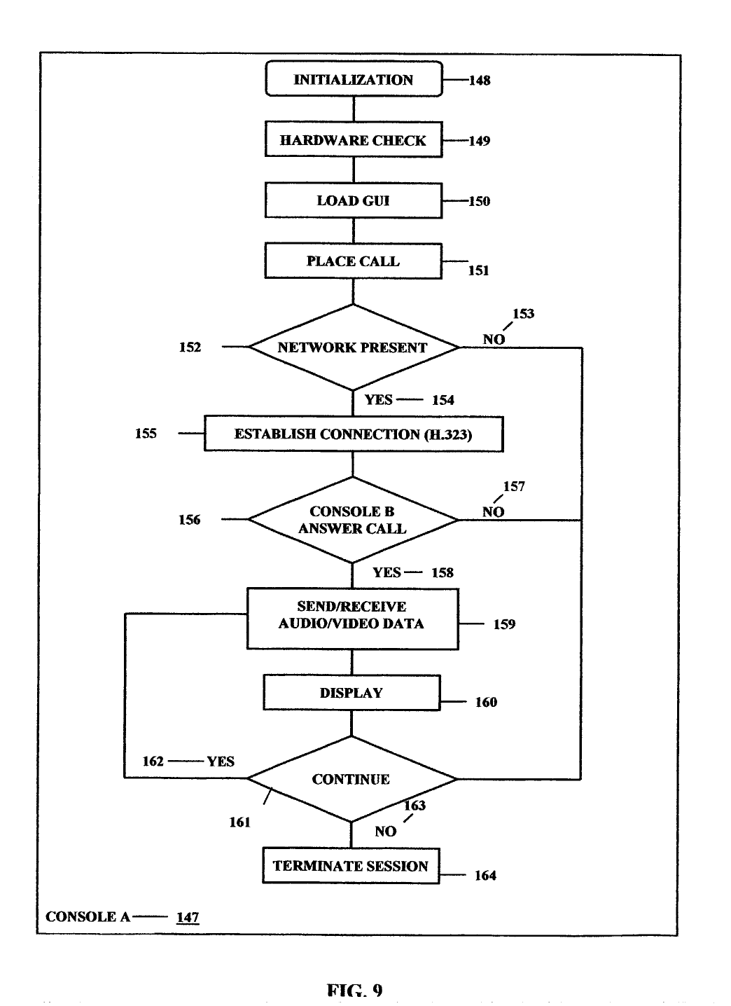

FIG. 9 represents the simplified logic flow of the component software for a videophone integrated with a game console according to one embodiment of the present invention. The software control of the present system will be described in greater detail in following sections.

The logic of the present invention is similar to the common process of making a phone call.

A user initializes the game console (148) by first powering the system on, and then inserting and loading the CD, DVD or game cartridge which contains the application program, device drivers for hardware interfaces to the console kernel and other supporting software. The application then checks for associated hardware (149) and intializes them as required. The application process then loads a GUI (150) which then will visually present the user with several options that can be selected by using the game console controller through the television.

A user can place a call (151), or contact people in several ways. By selecting items displayed on the GUI, the user can type in a computer network address, similar to a phone number, or can locate a person by using Corporate Directories, similar to a phone book, looking up a stored history list of people who have called, from a service such as the Internet Directory services Also, the present invention supports Lightweight Directory Access Protocol (LDAP), which is an Internet Standard that defines the protocol for directory access. The present invention uses LDAP to access the Internet Locator Service (ILS) and performs server transactions, including logging on and off, creating a directory listing of all available users, and resolving a particular user's address information, such as the IP address. Pressing the video game console controller, and using the GUI, the user selects the person that they would like to call.

The system then begins the process of placing a call. First, the software application checks the hardware configuration of the present system. Then it checks to see if a network is present (152). If a network is not present (153), it will stop and notify the user through the GUI that it cannot make a call. If it does find a network connection present (154), it will begin the process to intiate a call.

The first machine, Console A, requests to make a conference connection with another user, Console B (156). Console A sends an invitation to join in a conference or a conversation (155). This protocol is based on the H.323 standard and is described in greater detail below. If Console B is not active, unable to answer the call, or chooses not to answer the call, the application on Console A will identify the state of Console B on the screen, through the GUI.

If Console B is active, on the screen of that machine, a dialogue box will appear on the screen, identifying Console A, and asking if that person would like to accept the call (156). If Console B does not answer within a specified time range, Console A will close the connection and notify the user (157). If Console B does choose to answer the call (158), it will send a confirmation to Console A and they will begin the handshake protocol to establish the call, as described in greater detail further below.

Console A will then begin by capturing, formatting and sending data in the form of images and digitized voice to Console B (159), and display both the sent and received data on screen (160). This process continues (161) until a user selected termination point. Console B will follow the same process. The result is that Console A and Console B have established a videophone call (162). Either Console A or Console B can terminate the call at any time, by selecting the terminate button (163) on the GUI, and the result is the same as hanging up a phone after a phone conversation (164).

X. Graphical User Interface

FIG. 10 is a diagram illustrating an example window (165) that serves as the graphical user interface (GUI) for the present invention. The present invention example window consists of the main video conference window section (165), the phone book (166), the video display window or windows (167), and a set of icons at the bottom of the screen (168) that allow a user to enter information and make selections. These are displayed as output from a video game console on a television set (183). The main window (165) is the framework for organizing and displaying a video conference call. Within that main window are several components consisting of the following:

1. The Phone Book

The Phone Book (166) comprises several parts, all of which act in accordance with the function of allowing a user to select a person to make a video conference call to. Some of the information that is included in the phone book consists of a name of the person (169) address or location, a graphical image of the person or location (170), and other information associated with that person (171). Stored with each person or entry in the phone book is also an IP address, which the game console uses to ‘call’ that particular person or location. Multiple entries can be displayed (172, 173, 174).

2. The Video Display Window(s)

The Video Display window (167) consists of several parts as well, but the main function of the window is the ability and location to display the video images and data being received from the second game console or computer, and which makes up the visual part of a video conference call. Also associated with each unique image, is data (175) associated with the call, such as the user name, date, time, and location and other data. Multiple windows may be displayed (177,176).

3. Option Icons

The Option Icons comprises (168), but is not limited to, the following functions. One is the location where the user initiates a video conference call (178). By highlighting a person in the phone book and selecting this button, the program will execute the video conference call. Also, if a user would like to share (179) an executable program over the network, this is where that process is started. Options (180) such as background color or graphics, and other user selectable options are displayed here. Technical settings (181) including such things as data rate, image size, window size or resolution is provided here. If the user would like to operate a separate chat window with another participant, that option is available here (182).

XI. A Video Game Console Videophone Example

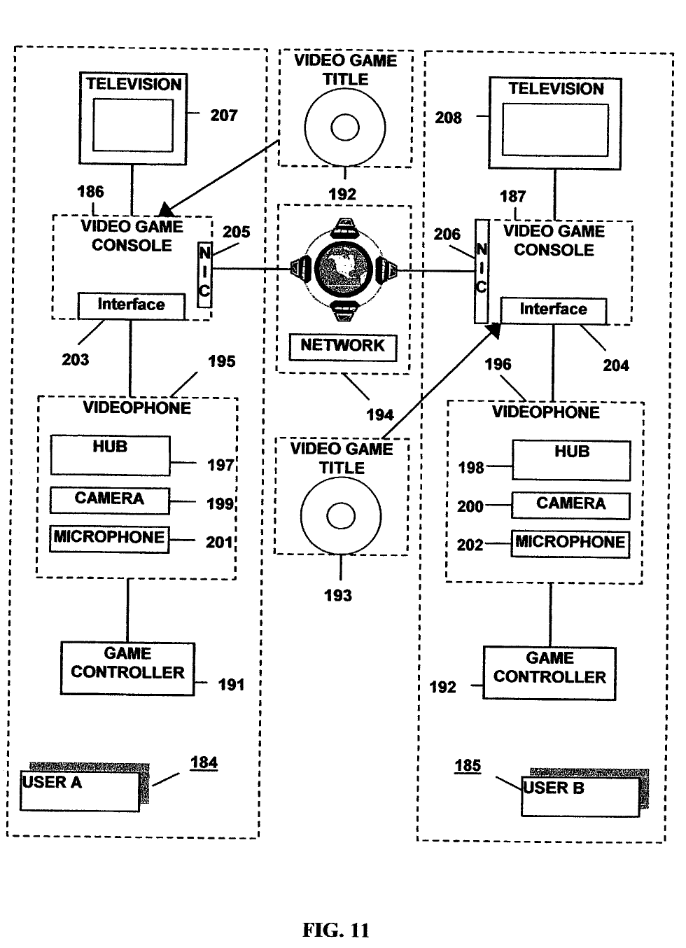

The operation of the present invention of FIG. 11 can be shown by example by describing a pair of users as they connect to each other in a videophone call with a video game console. FIG. 11 illustrates a point-to-point videoconference with audio and video signals, using a video game console and utilizing standard IP transport protocols as the transport mechanism. More specifically, this is an example of an H.323 based videoconference, which specifies the mandatory and optional requirements for the conference as well other major components.

For the purposes of this example, two user homes, User A's Home (184) and User B's Home (185) have video game consoles (186,187) that are connected to a network (194) by network interface cards (205,206). Each video game console system is running a client application or video game title (192,193), which has been created to support the capabilities described in the following paragraph. The main components of the basic system are:

Each system contains a videophone (195,196), which consists of a camera (199,200), a microphone (201,202), and a USB hub (197,198). A video game controller (190,191) is connected to the videophone. The videophone is connected (203,204) with USB cabling, to the video game console, via the USB hub. The video game console is also connected to a television (188,189) for video display and audio output.

User A (184) inserts the game title (192) into the video game console (186). Simultaneously, User B (210) follows the same steps. User A (184) then uses his video game controller to select the option of placing a call from the options presented by the graphical user interface (GUI). When User A (184) inputs the IP address of User B, the video game title application attempts to establish a H.323 connection. After it does this, it begins to send data from the camera and the microphone to the hub, which in turn relays that delay to the video game console. The game title application then organizes the data from the input devices and forwards that data to User B. At the same time, User B is undertaking the same process. Now both User A and User B are acting as endpoints in a videoconference. The game title application receives the data from User B over the network, and formats it appropriately for the output device, in this example a television set (207, 208).

Example Description

Jackson is a typical 11-year-old boy, who lives in California He has just come home from school, where he received an award for citizenship. He is very proud of his achievement and naturally wants to share his success with his family. After showing it to his parents, he decides to call his Nona, his grandmother, and who lives in Michigan.

In Jackson's living room at his house, he has an XBOX™, a product of the Microsoft Corporation, which is a video game console. The XBOX™ is connected to the television set with the standard AV (Audio/Visual) cable that comes with the system, and supports composite video input. The XBOX™ console has a power cord that is plugged into a wall outlet. An XBOX™ controller is connected to a controller port on the front of the XBOX™. The present invention, which contains a camera and a microphone, is connected with a USB cable to another port on the front of the XBOX™, and rests on top of the television set. A twisted pair network cable connects the Ethernet port on the back of the XBOX™, to a network hub with Internet access in another room of the house.

Jackson gets his DVD that comes with the present invention. He pushes the eject button on the front of the console to open the disc tray. He inserts the DVD into the disc tray, and presses the eject button again, causing the disc tray to close. The software of the present invention boots up, and is assigned an IP address from the network. The GUI is now displayed on screen and presents Jackson with a menu of selections.

At the same time, back in Michigan, Nona knows that Jackson is now out of school for the day and might like to talk to her. So she goes to her living room, where she has a PS2™, a product of the Sony Corporation, which is also a video game system. The PS2™ is set up similarly to the video game system at Jackson's house. The PS2™ is connected to the television set with the standard AV (Audio/Visual) cable that comes with the system, and supports composite video input The PS2™ console has a power cord that is plugged into a wall outlet. An PS2™ controller is connected to a controller port of the PS2™. The present invention, which contains a camera and a microphone, is connected with a USB cable to a USB port on the front of the PS2™, and rests on top of the television set. One difference between Jackson's system and Nona's is that instead of a network connection, Nona's has PS2™, an external modem. The modem is connected to a phone jack in her living room with a standard RJ-45 phone line.

Now Nona gets her DVD that comes with the present invention. She pushes the eject button on the front of the console to open the disc tray. She inserts the DVD into the disc tray, and presses the eject button again, causing the disc tray to close. The software of the present invention boots up, and this causes the application on the DVD to initializes the modem and dial into an ISP, where the machine is assigned a dynamic IP address. The GUI is now displayed on screen and presents Nona with a menu of selections.

At home in California, Jackson selects the menu item to place a call. He then goes down his list to pick Nona. The machine goes to a LDAP server, and associates the IP with Nona's name. Here is starts a H.3232 conference call. He can now see and here his grandma. They talk and Jackson holds up his citizenship award to the camera, and the that image is sent to Nona's house where she can see it and tell Jackson how proud she is.

Thus, an improved videophone for video game consoles has been described.

The specific arrangements and methods described herein are merely illustrative of the principles of the present invention. Those of ordinary skill in the art may make numerous modifications in form and detail without departing from the scope of the present invention. Although this invention has been shown in relation to a particular embodiment, it should not be considered so limited. Rather, the present invention is limited only by the scope of the appended claims.

I claim:

1. A first video game console system for linking said first video game console with a second video game console system, said first video game console system for establishing a videoconference between a first user on said first video game console system and a second user on said second video game console, said first video game console comprising:
a network interface coupled to a network;
a video game console;
a video game console controller;
a television or computer monitor for display and playback;
an apparatus and method for supporting equipment for said first video game console system comprising:
a video camera;
a microphone;
client application software, also referred to as a video game title, executing in said first video game console system, said client software application or game title comprising:
processing logic for connecting said first video game console system to a server on said network via said network interface;
processing logic for requesting network address information from said server;
processing logic for receiving a network address of said second video game console system from said server;
processing logic for disconnecting from said first video game console system from said server before establishing a direct connection link with said second video game console system using said network address;
processing logic for saving user information on said server from said first video game console system;
processing logic for compressing and decompressing audio and video streams;
a graphical user interface (GUI) for displaying information on screen, and allowing first user to input data and interact with equipment;
processing logic for reconnecting said first video game console system to a server coupled with said network; and
processing logic for uploading user information from said first video game console system to a server memory on said server.

2. The first video game console system as claimed in claim 1 wherein said client application software further includes processing logic for support of Lightweight Directory Access Protocol (LDAP).

3. The first video game console system as claimed in claim 1 wherein said client application software includes processing logic for support of the International Telephone Union (ITU) standard H.323 for specifications for computers, equipment and services carrying real-time audio, video, data, or any combination of these over said network.

4. The first video game console system as claimed in claim 1 wherein said client application software includes the ability to record the videoconference.

5. The first video game console system as claimed in claim 1 wherein said client application software includes the ability to transfer files.

6. The first video game console system as claimed in claim 1 wherein said client application software includes the ability to send and receive instant messages from said second video game console system.

7. The first video game console system as claimed in claim 1 wherein said client application software includes the ability to broadcast and/or multicast the audio and video streams from said first video game console system.

8. The first video game console system as claimed in claim 1 wherein said first video game console system includes a network hub for connecting video game console peripherals.

9. The first video game console system as claimed in claim 1 wherein said first video game console system includes a Universal Serial Bus (USB) hub for connecting video game console peripherals.

10. A system for directly linking a first video game console with a second video game console, said system also for establishing a videoconference between a first user on said first video game console and a second user on said second video game console, said system comprising:
a network;
a first video game console connected to said network;
a server coupled to said server including:
processing logic for receiving a direct request for linking said first video game console;
a video game console system comprising:
television or computer monitor for display and playback;
an apparatus and method for supporting equipment for said first video game console system comprising:
a video camera;
a microphone;
client application software, also referred to as a video game title, executing in said first video game console system, said client software application or game title comprising:
processing logic for connecting said first video game console system to a server on said network via said network interface;
processing logic for requesting network address information from said server;
processing logic for receiving a network address of said second video game console system from said server;
processing logic for disconnecting from said first video game console system from said server before establishing a direct connection link with said second video game console using said network address;
processing logic for saving user information on said server from said first video game console;
processing logic for compressing and decompressing audio and video streams;
a graphical user interface (GUI) for displaying information on screen, and allowing first video game console user to input data and interact with equipment;
processing logic for reconnecting said first video game console system to a server coupled with said network; and
processing logic for uploading user information from said first video game console system to a server memory on said server.

11. The system as claimed in claim 10 wherein said second video game console system is connected to said network, said second video game console system further including:
client application software executing in second video game console system, said client software including:
processing logic for downloading information from said server to said second video game console; and
processing logic for providing information in place of input from said second video game console for the execution of said videoconference.

12. The system as claimed in claim 10 wherein said first video game console system and said second video game console are identical.

13. The system as claimed in claim 10 wherein said first video game console system connects directly to a personal computer, hand-held device or cell phone.

14. In a computer network comprised of a plurality of video game consoles logically connected to either each other or a server, and each client video game console having a network interface card for communicating with a plurality of other video game consoles on the network, a method and apparatus for establishing a videoconferencing and videophone system, said system and apparatus comprising:
a network interface coupled to a network;
a video game console;
a video game console controller;
a television or computer monitor for display and playback;
an apparatus and method for supporting equipment for said video game console system comprising:
a video camera;
a microphone;
client application software, also referred to as a video game title, executing in said first video game console system, said client software application or game title comprising:
processing logic for connecting said first video game console system to a server on said network via said network interface;
processing logic for requesting network address information from said server;
processing logic for receiving a network address of said second video game console system from said server;
processing logic for disconnecting from said first video game console system from said server before establishing a direct connection link with said second video game console system using said network address;
processing logic for saving user information on said server from said first video game console system;
processing logic for compressing and decompressing audio and video streams;
a graphical user interface (GUI) for displaying information on screen, and allowing first video game console system to input data and interact with equipment;
processing logic for reconnecting said first video game console system to a server coupled with said network; and
processing logic for uploading user information from said first video game console system to a server memory on said server.

15. The system as claimed in claim 14 wherein said client application software further includes processing logic for the uploading of user information to said server.

16. The system as claimed in claim 14 wherein said client application software further includes processing logic for recording the videoconference.

17. The system as claimed in claim 14 wherein said client application software further includes processing logic for playing the recorded videoconference.

18. The system as claimed in claim 14 wherein said system further comprises the ability to insert a commercial or advertisement in the form of a video clip or file, directly into the streamed connection from a network server to a video game console system.
